(19) United States
(12) Patent Application Publication
(10) Pub. No.: US 2026/0211490 A1
(43) Pub. Date: Jul. 23, 2026

(54) INTERACTION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Na PANG, Beijing (CN); Yiping Yang, Beijing (CN); Zhenyi Qu, Beijing (CN); Songling Tian, Beijing (CN)

(21) Appl. No.: 19/450,559

(22) Filed: Jan. 15, 2026

(30) Foreign Application Priority Data
Jan. 17, 2025 (CN) 202510081311.3

(51) Int. Cl. G06F 3/01; G06T 19/00

(52) U.S. Cl. CPC G06F 3/012; G06T 19/006

(57) ABSTRACT

The present disclosure relates to an interaction method and apparatus, an electronic device, and a storage medium. The method includes: displaying a broadcast control component and a relative pose locking option in an extended reality space, wherein the broadcast control component includes a video playing window and a playing control option, and the video playing window is configured to play a video; and setting a relative pose of a user’s head and the broadcast control component to a locked state in response to a select operation on the relative pose locking option, wherein in a case where the relative pose of the user’s head and the broadcast control component is in the locked state, the broadcast control component moves with the user’s head, and the relative pose of the user’s head and the broadcast control component is always kept unchanged.

### CROSS-REFERENCE TO RELATED APPLICATION(S

The present disclosure claims the priority from the CN patent application No. 202510081311.3 entitled “Interaction method and apparatus, electronic device, and storage medium” filed with the China National Intellectual Property Administration (CNIPA) on January 17, 2025, the contents of which are hereby incorporated by reference in their entirety.

### FIELD

The present disclosure relates to the technical field of extended reality, and in particular, to an interaction method and apparatus, an electronic device, and a storage medium.

### BACKGROUND

With the continuous progress of science and technology, extended reality (XR) devices are gradually entering people's lives, and their functions are becoming increasingly rich, among which the video viewing function has attracted much attention from users. At present, most extended reality devices mainly realize video playing by means of a video playing window in an extended reality environment constructed by the devices.

### SUMMARY

The present disclosure provides an interaction method and apparatus, an electronic device, and a storage medium.

In a first aspect, the present disclosure provides an interaction method, including:

displaying a broadcast control component and a relative pose locking option in an extended reality space, where the broadcast control component includes a video playing window and a playing control option, and the video playing window is configured to play a video; and

setting a relative pose of a user’s head and the broadcast control component to a locked state in response to a select operation on the relative pose locking option, where in the case where the relative pose of the user’s head and the broadcast control component is in the locked state, the broadcast control component moves with the user’s head, and the relative pose of the user’s head and the broadcast control component is always kept unchanged.

In a second aspect, the present disclosure further provides an interaction apparatus, including:

a displaying module, configured to display a broadcast control component and a relative pose locking option in an extended reality space, where the broadcast control component includes a video playing window and a playing control option, and the video playing window is configured to play a video; and

a setting module, configured to set a relative pose of a user’s head and the broadcast control component to a locked state in response to a select operation on the relative pose locking option, where in the case where the relative pose of the user’s head and the broadcast control component is in the locked state, the broadcast control component moves with the user’s head, and the relative pose of the user’s head and the broadcast control component is always kept unchanged.

In a third aspect, the present disclosure further provides an electronic device, including:

one or more processors; and

a storage apparatus, configured to store one or more programs,

where the one or more programs, when executed by the one or more processors, cause the one or more processors to implement the interaction method according to the above.

In a fourth aspect, the present disclosure further provides a computer-readable storage medium, on which a computer program is stored, where the computer program, when executed by a processor, implements the interaction method according to the above.

### BRIEF DESCRIPTION OF THE DRAWINGS

The drawings herein, which are incorporated in and constitute a part of this specification, illustrate embodiments consistent with the present disclosure and, together with the description, serve to explain the principles of the present disclosure.

In order to more clearly explain the technical solutions in the embodiments of the present disclosure or in the prior art, the drawings that need to be used in the description of the embodiments or the prior art will be briefly introduced below. Obviously, for those of ordinary skill in the art, other drawings may be obtained according to these drawings without paying any creative effort.

FIG. 1 is a flowchart of an interaction method provided by an embodiment of the present disclosure;

FIG. 2 is a schematic diagram of playing a panoramic video provided by an embodiment of the present disclosure;

FIG. 3 is a structural schematic diagram of an interaction apparatus provided by an embodiment of the present disclosure; and

FIG. 4 is a structural schematic diagram of an electronic device provided by an embodiment of the present disclosure.

### DETAILED DESCRIPTION OF EMBODIMENTS

In order to understand the above objects, features and advantages of the present disclosure more clearly, the solutions of the present disclosure will be further described below. It should be noted that the embodiments of the present disclosure and the features in the embodiments may be combined with each other without conflict.

Many specific details are set forth in the following description to facilitate a full understanding of the present disclosure, but the present disclosure may also be implemented in other ways different from those described herein. Obviously, the described embodiments are part of the embodiments of the present disclosure, but not all of the embodiments.

With the continuous progress of science and technology, extended reality (XR) devices are gradually entering people's lives, and their functions are becoming increasingly rich, among which the video viewing function has attracted much attention from users. At present, most extended reality devices mainly realize video playing by means of a video playing window in an extended reality environment constructed by the devices. However, in practical applications, due to the unreasonable setting scheme of the existing video playing window, the user is prone to viewing fatigue, and the immersion of viewing videos is affected.

As recorded in the background art, the existing setting scheme of the video playing window has defects, which easily leads to viewing fatigue of the user and impairs the immersive experience of viewing videos. After in-depth analysis, the applicant believes that one reason for this problem is that the video playing window is always in a fixed position in the extended reality space when the user is in a moving state. Specifically, because the position of the video playing window is fixed in the extended reality space, the user needs to constantly adjust the head angle to keep the video playing window within the field of view if the user needs to continue watching videos when moving, and such frequent head movements easily make the user feel fatigued. In addition, because the position of the video playing window is constant in the extended reality space, the immersive state of viewing videos will be broken once the user starts to move.

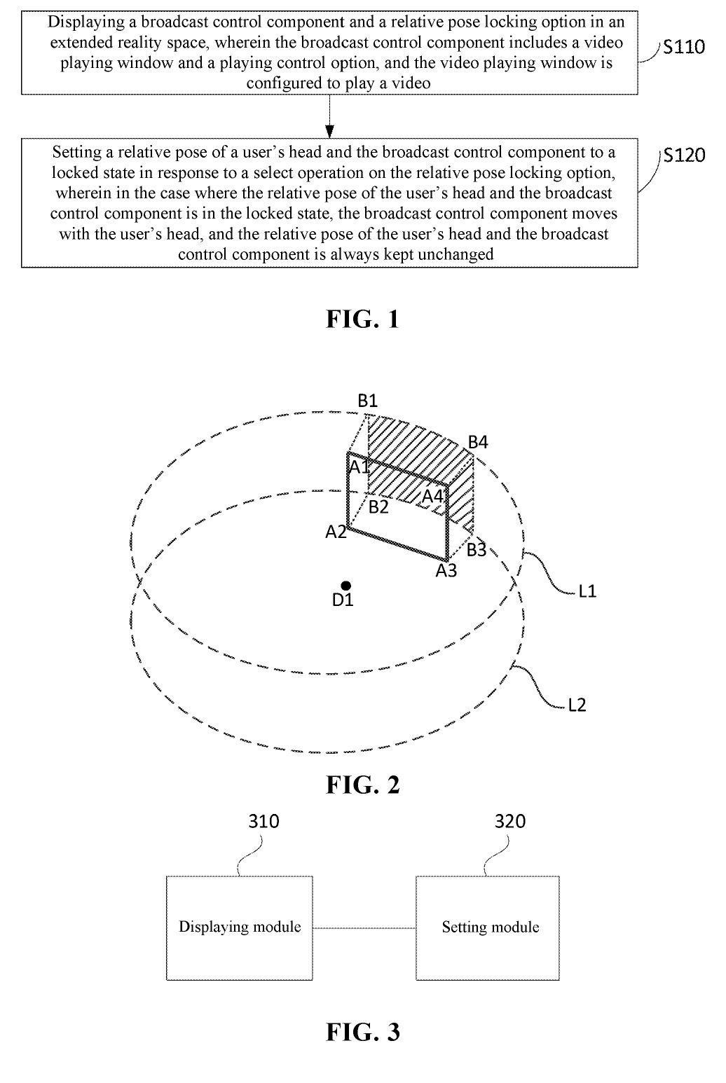

In view of this, FIG. 1 is a flowchart of an interaction method provided by an embodiment of the present disclosure. The embodiment may be applied to a case of interaction in a client. The method may be executed by an interaction apparatus, which may be implemented by means of software and/or hardware and may be configured in an extended reality device.

The extended reality device recorded in the present application may include but is not limited to the following types:

a computer-side extended reality device, which uses a PC-side to perform related calculations and data output of an extended reality function, and an external computer-side extended reality device uses data output by the PC-side to implement an extended reality effect;

a mobile extended reality device, which supports setting a mobile terminal (such as a smart phone) in various ways (such as a head-mounted display provided with a dedicated card slot), is connected to the mobile terminal in a wired or wireless manner, and performs related calculations of an extended reality function by the mobile terminal, and outputs data to the mobile extended reality device, for example, watches an extended reality video through an APP of the mobile terminal; and

an all-in-one extended reality device, which is provided with a processor for performing related calculations of a virtual function, thus having an independent extended reality input and output function, and does not need to be connected to a PC-side or a mobile terminal, and has a high degree of freedom in use.

As shown in FIG. 1, the method may specifically include:

S110, displaying a broadcast control component and a relative pose locking option in an extended reality space, where the broadcast control component includes a video playing window and a playing control option, and the video playing window is configured to play a video.

The extended reality space may be, for example, a virtual scene created by means of an environmental image when the extended reality device is running. The virtual scene may be a simulation environment of the real world, or may be a semi-simulation and semi-fictional virtual scene, and may also be a pure fictional virtual scene. The extended reality space may include sky, land, ocean, etc., and the land may include environmental elements such as desert, city, etc., and the user may move in the extended reality space. The environmental image is equivalent to the desktop wallpaper displayed after the computer is turned on.

The broadcast control component may be, for example, a functional component displayed in the extended reality space for performing video playing and controlling. In practice, the broadcast control component may be displayed in the extended reality space in a form of a panel.

The video playing window may be, for example, an area of the broadcast control component for playing a video. The video played by the video playing window may include at least one of the following: ordinary (non-VR) 2D video, ordinary (non-VR) 3D video, panoramic video, 2D fisheye video, 3D fisheye video, and spatial video.

The playing control option may be, for example, at least one of the following: play/pause control, volume adjustment control, fast forward control, fast rewind control, viewing mode selection control, stereoscopic effect selection control, panoramic angle selection control, subtitle switch control, audio track selection control, spatial audio control, playlist control, video 2D/3D type selection control, VR projection format selection control, and viewing scene selection control.

In practice, the video playing window and the playing control option may be located on different spatial planes of the extended reality space, or the video playing window and the playing control option are located in different position areas of the same plane in the extended reality space, which is not limited in the embodiments of the present disclosure. For example, the position and orientation of the video playing window and the playing control option in the extended reality space may be set based on the viewing distance of the user, for example, the distance between the video playing window and the user is farther than the distance between the playing control option and the user.

The relative pose locking option may be, for example, an option for setting whether to enable a relative pose locking function. The relative pose locking option may be an option for controlling the playing mode and independent of other playing control options; or may be a sub-option of a certain playing control option; and may also be a sub-option of system settings. The system settings may be, for example, a function set for configuring and managing the overall operating environment, functional characteristics and personalized preferences of the device or software.

The relative pose locking option and the playing control option may be located in different position areas of the same plane in the extended reality space, and may also be located on different spatial planes of the extended reality space.

S120, setting a relative pose of a user’s head and the broadcast control component to a locked state in response to a select operation on the relative pose locking option, where in the case where the relative pose of the user’s head and the broadcast control component is in the locked state, the broadcast control component moves with the user’s head, and the relative pose of the user’s head and the broadcast control component is always kept unchanged.

The select operation on the relative pose locking option may be, for example, an operation indicating that the user desires to enable the relative pose locking function. Exemplarily, the select operation on the relative pose locking option may be, for example, a click operation or a drag operation on the relative pose locking option.

The relative pose of the user’s head and the broadcast control component may be, for example, a relative position and a relative posture of the user’s head and the broadcast control component in the extended reality space. The relative position reflects a distance relationship between the two in a three-dimensional space, and the relative posture reflects an orientation relationship between the two.

When the relative pose of the user’s head and the broadcast control component is in the locked state, the relative position and orientation between the user’s head and the broadcast control component maintain a set initial state, no matter how the user’s head moves or rotates at any angle. From the perspective of user experience, when the relative pose of the user’s head and the broadcast control component is in the locked state, the broadcast control component seems to be stuck at a fixed distance and angle in front of the user’s eyes. No matter whether the user’s head moves up, down, left, right, forward or backward, or even rotates, the broadcast control component always remains in a relative position in the user’s field of view, and no angular tilt or distance change will occur. In this way, no matter how the user changes the position and direction of the head in the virtual space, the user may conveniently watch videos and operate the playing control option through the video playing window, without searching for the position of the broadcast control component again or adjusting the viewing angle to adapt to the broadcast control component.

According to the above technical solutions, the broadcast control component and the relative pose locking option are displayed in the extended reality space, where the broadcast control component includes the video playing window and the playing control option, and the video playing window is configured to play the video; and the relative pose of the user’s head and the broadcast control component is set to the locked state in response to the select operation on the relative pose locking option, where in the case where the relative pose of the user’s head and the broadcast control component is in the locked state, the broadcast control component moves with the user’s head, and the relative pose of the user’s head and the broadcast control component is always kept unchanged. The essence is to provide a video viewing mode in which the broadcast control component may move with the user’s head and the relative pose of the two is always constant. In this way, even if the position and posture of the user’s head change, there is no need to frequently adjust the head angle to keep the video playing window within the field of view, thereby reducing the fatigue of the user when viewing videos. In addition, the immersive state of the user when viewing videos will not be interrupted due to the changes of the position and posture of the head.

Based on the above technical solutions, optionally, the method may further include: acquiring user head pose change information in the case where the relative pose of the user’s head and the broadcast control component is in the locked state; determining first pose information of the broadcast control component based on the user head pose change information; and setting pose information of the broadcast control component to the first pose information, such that the broadcast control component moves with the user’s head, and the relative pose of the user’s head and the broadcast control component is always kept unchanged.

In the extended reality device, multiple sensors are usually provided, such as an IMU (Inertial Measurement Unit), a 3Dof & 6Dof (three degrees of freedom & six degrees of freedom) sensor, and an eye tracking camera (for example, an infrared (IR) or near infrared (NIR) camera). The user head pose change information may be determined based on data collected by means of these sensors.

The first pose information may be, for example, a position and a posture to which the broadcast control component needs to be adjusted in order to achieve the purpose that "the broadcast control component moves with the user’s head, and the relative pose of the user’s head and the broadcast control component is always kept unchanged".

There are multiple specific implementation methods of "determining the first pose information of the broadcast control component based on the user head pose change information", which is limited in the present application. Exemplarily, the specific implementation method of "determining the first pose information of the broadcast control component based on the user head pose change information" may include: determining initial pose information of the broadcast control component in the extended reality space and initial pose information of the user’s head in the extended reality space at an initial time, where the initial time is a time when the select operation on the relative pose locking option is detected; determining a relative pose between the user’s head and the broadcast control component based on the initial pose information of the broadcast control component in the extended reality space and the initial pose information of the user’s head in the extended reality space at the initial time; and determining the first pose information of the broadcast control component based on the user head pose change information and the relative pose between the user’s head and the broadcast control component.

Exemplarily, if the operation of the user clicking on the relative pose locking option is regarded as the select operation on the relative pose locking option, the initial time is the time when it is detected that the user clicks on the relative pose locking option. If the pose information includes position information and posture information, initial position information Pos1 of the video playing window in the extended reality space, initial position information Pos2 of the playing control option in the extended reality space and initial position information PosU of the user’s head in the extended reality space are recorded at the initial time, and a relative position difference △Pos1 between the user’s head and the video playing window and a relative position difference △Pos2 between the user’s head and the playing control option are:

△Pos1 = PosU - Pos1

△Pos2 = PosU - Pos2

At a subsequent time, the pose of the user’s head changes. It is assumed that new position information of the user’s head in the extended reality space is PosU' after the pose of the user’s head changes, Pos1' represents new position information of the video playing window in the extended reality space, and Pos2' represents new position information of the playing control option in the extended reality space. Then

Pos1' = PosU' - △Pos1

Pos2' = PosU' - △Pos2.

The position information of the video playing window is set to Pos1', and the position information of the playing control option is set to Pos2'.

It is assumed that the Euler angle by which the user rotates is EulerU after the pose of the user’s head changes. Based on the Euler angle EulerU by which the user rotates, the target Euler angle of the broadcast control component may be determined, and then the rotation angle of the broadcast control component is adjusted to be equal to the target Euler angle.

It should be noted that in practice, when rendering each frame of image, the steps of "acquiring the user head pose change information in the case where the relative pose of the user’s head and the broadcast control component is in the locked state; determining the first pose information of the broadcast control component based on the user head pose change information; and setting the pose information of the broadcast control component to the first pose information" need to be performed.

Based on the above technical solutions, optionally, if the video played by the broadcast control component is a panoramic video, the panoramic video has a geometric model corresponding thereto, and a relative pose of the broadcast control component and the geometric model is fixed, the method further includes: determining the relative pose of the broadcast control component and the geometric model; determining second pose information of the geometric model based on the first pose information of the broadcast control component and the relative pose of the broadcast control component and the geometric model; and setting pose information of the geometric model to the second pose information.

The geometric model corresponding to the panoramic video may be a three-dimensional geometric model for carrying a panoramic video image, and its surface is used as a mapping carrier for the content of the panoramic video image. There is a correspondence between points on the surface of the geometric model and pixel points in the panoramic video image, and this correspondence may be determined by means of a specific projection method. In practice, the geometric model corresponding to the panoramic video may include a cubic model or a spherical model, etc. If the geometric model corresponding to the panoramic video is the spherical model, the projection method used to determine the correspondence between the points on the surface of the spherical model and the pixel points in the panoramic video image may be a spherical projection method such as an equirectangular projection or an adjusted equal-area projection (AEP). By virtue of the correspondence between the points on the surface of the geometric model and the pixel points in the panoramic video image, the panoramic image may be accurately "attached" to the surface of the geometric model.

In some scenes, the panoramic video is played by using the video playing window, and the video playing window is similar to a window, and the user watches the panoramic video through the video playing window, which is similar to the user observing the scenery outside the window "through" the window. Specifically, referring to FIG. 2, the extended reality space includes a user (D1 in FIG. 2 represents the position of the user in the extended reality space), a video playing window A1A2A3A4, and a spherical model corresponding to a panoramic video. In FIG. 2, a circle L1 and a circle L2 are two circles on the spherical model corresponding to the panoramic video. The user located at the position D1 may watch the panoramic video image "attached" to the spherical model through the video playing window A1A2A3A4. Moreover, due to the limitation of the video playing window A1A2A3A4, the user may only see an image "attached" to a local area on the surface of the spherical model. Exemplarily, when the user is at the position D1 in FIG. 2, the user may only see an image "attached" to an area B1B2B3B4 on the surface of the spherical model. In other words, when the panoramic video is played by using the video playing window, the video playing window may only display an image of a specific area of the panoramic video image.

The second pose information of the geometric model may be, for example, a position and a posture to which the geometric model needs to be adjusted in order to achieve the purpose that "the broadcast control component moves with the user’s head, and the relative pose of the user’s head and the broadcast control component is always kept unchanged".

Generally, when the user performs the select operation on the relative pose locking option, it indicates that the user desires that the video playing window keeps displaying the image of the specific area in the panoramic video image. By setting to determine the second pose information of the geometric model based on the first pose information of the broadcast control component and the relative pose of the broadcast control component and the geometric model, and set the pose information of the geometric model to the second pose information, it may be ensured that in the case where the relative pose of the user’s head and the broadcast control component is in the locked state, even if the position and/or posture of the user’s head changes, the video playing window always displays the image of the same specific area of the panoramic video image. In this way, the user may not miss image details in the specific area no matter how the head moves when the user is watching the panoramic video.

Based on the above technical solutions, optionally, the method may further include: determining a user head moving distance based on the user head pose change information in the case where an extended reality device is in a see-through mode; and increasing transparency of the broadcast control component if the user head moving distance is greater than a set distance threshold.

The see-through mode may be, for example, that the user may observe the real external environment in addition to the broadcast control component in the extended reality space. In this case, the implementation may be to capture images of the real external environment where the user is located by means of sensors such as a camera, and superimpose images of the broadcast control component on these images, thereby forming the visual effect of the see-through mode.

Increasing the transparency of the broadcast control component may expose things occluded by the broadcast control component. In the see-through mode, the things occluded by the broadcast control component are things in the real external environment where the user is located. By setting to determine the user head moving distance based on the user head pose change information in the case where the extended reality device is in the see-through mode, and increase the transparency of the broadcast control component if the user head moving distance is greater than the set distance threshold, it may avoid the safety risk caused by the broadcast control component occluding the user’s field of view during the movement of the user, and it may meet the needs of the user, such as watching videos while moving in a small range indoors.

Based on the above technical solutions, optionally, displaying the relative pose locking option in the extended reality space includes: displaying the relative pose locking option in the extended reality space in the case where the extended reality device is in a first working mode, where the first working mode includes an all-black mode or a see-through mode.

The all-black mode may be, for example, an interaction model in which the user may not observe other virtual or real things in the extended reality space except the broadcast control component. In other words, in the all-black mode, the remaining space is presented in black except the broadcast control component.

In the all-black mode, external interference is completely shielded. If the user sets the working mode of the extended reality device to the all-black mode, it means that the user desires to watch videos immersively. In this case, by setting to display the relative pose locking option in the extended reality space, it means that the relative pose of the user’s head and the broadcast control component is allowed to be locked, so as to further reduce the number of times that the immersive state of the user when watching videos is interrupted, which is helpful to improve the immersive experience of the user.

If the user sets the working mode of the extended reality device to the see-through mode, it means that the user needs to watch the real surrounding environment. In this case, by setting to display the relative pose locking option in the extended reality space, it means that the relative pose of the user’s head and the broadcast control component is allowed to be locked, so that the user does not need to frequently adjust the head angle to keep the video playing window within the field of view, thereby reducing the fatigue of the user when watching videos and improving the viewing experience of the user.

Further, a relative pose of a user’s head and the broadcast control component is set to an unlocked state in response to an instruction to switch a working mode of the extended reality device to a second working mode, where in the case where the relative pose of the user’s head and the broadcast control component is in the unlocked state, the broadcast control component does not move with the user’s head, and the relative pose of the user’s head and the broadcast control component is variable, and the second working mode includes a virtual viewing mode.

The virtual viewing mode may be, for example, that the user may observe things in a virtual environment in addition to the broadcast control component in the extended reality space. In this viewing mode, the user is completely isolated from the external environment, and the virtual environment seen by the user is pure fiction.

The virtual viewing mode is originally designed to simulate that the user watches videos in a virtual cinema or other viewing environments. In this scene, the user may freely observe directions and details in the virtual environment, for example, may look up at the ceiling of the virtual cinema, or turn the head to observe surrounding virtual audiences, etc., so that the user may be more deeply immersed in the virtual viewing atmosphere. By setting to set the relative pose of the user’s head and the broadcast control component to the unlocked state in response to the instruction to switch the working mode of the extended reality device to the second working mode, it is beneficial for the user to freely observe the directions and details in the virtual environment.

It should be noted that, for the sake of simple description, the foregoing method embodiments are all expressed as a series of action combinations, but those skilled in the art should know that the present invention is not limited by the described action order, because according to the present invention, certain steps may be performed in other orders or simultaneously. Secondly, those skilled in the art should also know that the embodiments described in the specification all belong to preferred embodiments, and the involved actions and modules are not necessarily required by the present invention.

FIG. 3 is a structural schematic diagram of an interaction apparatus according to an embodiment of the present disclosure. The interaction apparatus provided by the embodiment of the present disclosure may be configured in a client or a server. Referring to FIG. 3, the interaction apparatus specifically includes:

a displaying module 310, configured to display a broadcast control component and a relative pose locking option in an extended reality space, where the broadcast control component includes a video playing window and a playing control option, and the video playing window is configured to play a video; and

a setting module 320, configured to set a relative pose of a user’s head and the broadcast control component to a locked state in response to a select operation on the relative pose locking option, where in the case where the relative pose of the user’s head and the broadcast control component is in the locked state, the broadcast control component moves with the user’s head, and the relative pose of the user’s head and the broadcast control component is always kept unchanged.

Further, the apparatus further includes an adjusting module, configured to:

acquire user head pose change information in the case where the relative pose of the user’s head and the broadcast control component is in the locked state;

determine first pose information of the broadcast control component based on the user head pose change information; and

set pose information of the broadcast control component to the first pose information, such that the broadcast control component moves with the user’s head, and the relative pose of the user’s head and the broadcast control component is always kept unchanged.

Further, the adjusting module is configured to:

determine initial pose information of the broadcast control component in the extended reality space and initial pose information of the user’s head in the extended reality space at an initial time, where the initial time is a time when the select operation on the relative pose locking option is detected;

determine a relative pose between the user’s head and the broadcast control component based on the initial pose information of the broadcast control component in the extended reality space and the initial pose information of the user’s head in the extended reality space at the initial time; and

determine the first pose information of the broadcast control component based on the user head pose change information and the relative pose between the user’s head and the broadcast control component.

Further, if the video played by the broadcast control component is a panoramic video, the panoramic video has a geometric model corresponding thereto, and a relative pose of the broadcast control component and the geometric model is fixed, the adjusting module is configured to:

determine the relative pose of the broadcast control component and the geometric model;

determine second pose information of the geometric model based on the first pose information of the broadcast control component and the relative pose of the broadcast control component and the geometric model; and

set pose information of the geometric model to the second pose information.

Further, the adjusting module is configured to:

determine the user head moving distance based on the user head pose change information in the case where an extended reality device is in a see-through mode; and

increase transparency of the broadcast control component if the user head moving distance is greater than a set distance threshold.

Further, the displaying module is configured to:

display the relative pose locking option in the extended reality space in the case where the extended reality device is in a first working mode, where the first working mode includes an all-black mode or the see-through mode.

Further, the apparatus further includes an exiting module, configured to:

set a relative pose of a user’s head and the broadcast control component to an unlocked state in response to an instruction to switch a working mode of the extended reality device to a second working mode, where in the case where the relative pose of the user’s head and the broadcast control component is in the unlocked state, the broadcast control component does not move with the user’s head, and the relative pose of the user’s head and the broadcast control component is variable, and the second working mode includes a virtual viewing mode.

The interaction apparatus provided by the embodiment of the present disclosure may execute the steps executed by the client or the server in the interaction method provided by the method embodiment of the present disclosure, and has the steps and beneficial effects of execution, which will not be repeated herein.

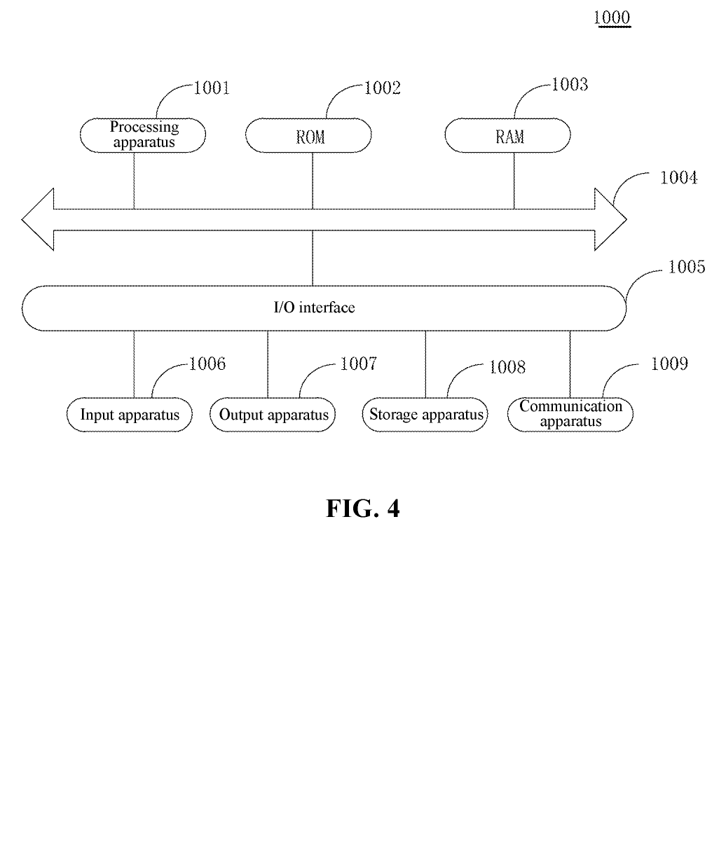

FIG. 4 is a structural schematic diagram of an electronic device according to an embodiment of the present disclosure. Reference is made specifically to FIG. 4 below, which is a structural schematic diagram of an electronic device 1000 suitable for implementing the embodiments of the present disclosure. The electronic device 1000 in the embodiments of the present disclosure may include but be not limited to mobile terminals such as a mobile phone, a laptop, a digital broadcast receiver, a PDA (personal digital assistant), a tablet computer, a PMP (portable multimedia player), a vehicle-mounted terminal (such as a vehicle-mounted navigation terminal), a wearable electronic device, etc., and fixed terminals such as a digital TV, a desktop computer, a smart home device, etc. The electronic device shown in FIG. 4 is only an example, and should not impose any limitation on the functions and scope of use of the embodiments of the present disclosure.

As shown in FIG. 4, the electronic device 1000 may include a processing apparatus (e.g., a central processing unit, a graphics processing unit, etc.) 1001, which may perform various appropriate actions and processes according to a program stored in a read-only memory (ROM) 1002 or a program loaded from a storage apparatus 1008 into a random access memory (RAM) 1003 to implement the interaction method of the embodiments as described in the present disclosure. In the RAM 1003, various programs and information required for operations of the electronic device 1000 are also stored. The processing apparatus 1001, the ROM 1002, and the RAM 1003 are interconnected by means of a bus 1004. An input/output (I/O) interface 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, a gyroscope, etc.; an output apparatus 1007 including, for example, a liquid crystal display (LCD), a speaker, a vibrator, etc.; the storage apparatus 1008 including, for example, a magnetic tape, a hard disk, etc.; and a communication apparatus 1009. The communication apparatus 1009 may allow the electronic device 1000 to perform wireless or wired communication with other devices to exchange information. Although FIG. 4 shows the electronic device 1000 having various apparatuses, it should be understood that not all the apparatuses shown here need to be implemented or provided. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program code for performing the method shown in the flowchart, thereby implementing the interaction method as described above. In such an embodiment, the computer program may be downloaded and installed from a network through the communication apparatus 1009, or installed from the storage apparatus 1008, or installed from the ROM 1002. When the computer program is executed by the processing apparatus 1001, the above functions defined in the method of the embodiments of the present disclosure are executed.

It should be noted that the above computer-readable medium in the present disclosure may be a computer-readable signal medium or a computer-readable storage medium or any combination of the two. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus or device. In the present disclosure, the computer-readable signal medium may include an information signal propagated in a baseband or as a part of a carrier wave, and computer-readable program code is carried therein. This propagated information signal may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program used by or in combination with the instruction execution system, apparatus or device. The program code contained on the computer-readable medium may be transmitted by any suitable medium, including but not limited to: a wire, an optical cable, an RF (radio frequency), etc., or any suitable combination of the above.

In some implementations, the client and the server may communicate using any known or future developed network protocol, such as the HTTP (HyperText Transfer Protocol), and may be interconnected with any form or medium of digital information communication (for example, a communication network). Examples of the communication network include a local area network ("LAN"), a wide area network ("WAN"), an internet (for example, the Internet), a peer-to-peer network (for example, an Ad-Hoc network), and any network known or to be developed in the future.

The above computer-readable medium may be included in the above electronic device, or it may exist alone without being assembled into the electronic device.

The above computer-readable medium carries one or more programs, and when the one or more programs are executed by the electronic device, the electronic device:

displays a broadcast control component and a relative pose locking option in an extended reality space, where the broadcast control component includes a video playing window and a playing control option, and the video playing window is configured to play a video; and

sets a relative pose of a user’s head and the broadcast control component to a locked state in response to a select operation on the relative pose locking option, where in the case where the relative pose of the user’s head and the broadcast control component is in the locked state, the broadcast control component moves with the user’s head, and the relative pose of the user’s head and the broadcast control component is always kept unchanged.

Optionally, when the one or more programs are executed by the electronic device, the electronic device may further perform other steps described in the above embodiments.

The computer program code for performing the operations of the present disclosure may be written in one or more programming languages or a combination thereof, where the above programming languages include but are not limited to object-oriented programming languages such as Java, Smalltalk, and C++, and further include conventional procedural programming languages such as "C" language or similar programming languages. The program code may be executed entirely on a user's computer, partly on the user's computer, as a stand-alone software package, partly on the user's computer and partly on a remote computer, or entirely on the remote computer or server. In the case of involving the remote computer, the remote computer may be connected to the user's computer through any kind of network, including a local area network (LAN) or a wide area network (WAN), or it may be connected to an external computer (for example, connected by using Internet provided by an Internet service provider).

The drawings illustrate the architecture, functionality, and operation of possible implementations of the systems, methods and computer program products according to various embodiments of the present disclosure. In this regard, each block in the flowchart or block diagrams may represent a module, program segment, or portion of code, which includes one or more executable instructions for implementing the specified logical function. It should also be noted that, in some alternative implementations, the functions indicated in the block may occur in an order different from that indicated in the drawings. For example, two blocks shown in succession may, in fact, be executed substantially concurrently, or the blocks may sometimes be executed in the reverse order, depending upon the functionality involved. It also should be noted that each block of the block diagrams and/or flowcharts, or a combination of blocks in the block diagrams and/or flowcharts may be implemented in a special purpose hardware-based system that perform a specified function or operation, or may be implemented in a combination of special purpose hardware and a computer instruction.

The units involved in the embodiments of the present disclosure may be implemented by means of software or by means of hardware. The name of the unit does not constitute a limitation on the unit itself under certain circumstances.

The functions described above herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

According to one or more embodiments of the present disclosure, the present disclosure provides an electronic device, including:

one or more processors; and

a memory, configured to store one or more programs,

where the one or more programs, when executed by the one or more processors, cause the one or more processors to implement the interaction method according to any one provided by the present disclosure.

According to one or more embodiments of the present disclosure, the present disclosure provides a computer-readable storage medium, on which a computer program is stored, where the computer program, when executed by a processor, implements the interaction method according to any one provided by the present disclosure.

An embodiment of the present disclosure further provides a computer program product, which includes a computer program or instructions, where the computer program or instructions, when executed by a processor, implement the interaction method as described above.

It should be noted that in this paper, relational terms such as "first" and "second" are only used to distinguish one entity or operation from another entity or operation, and do not necessarily require or imply any actual relationship or order between these entities or operations. Moreover, terms "include", "include" or any other variation thereof are intended to cover non-exclusive inclusion, so that a process, method, object or device including a series of elements includes not only those elements, but also other elements not explicitly listed or elements inherent to such process, method, object or device. Without further restrictions, an element defined by a phrase "including a" does not exclude that there are other identical elements in the process, method, object or device including the element.

The above descriptions are only specific embodiments of the present disclosure, so that those skilled in the art may understand or implement the present disclosure. Various modifications to these embodiments will be apparent to those skilled in the art, and general principles defined herein may be implemented in other embodiments without departing from the spirit or scope of the present disclosure. Therefore, the present disclosure will not be limited to these embodiments described herein, but rather to the widest scope consistent with the principles and novel features disclosed herein.

I/We claim:

1. An interaction method, comprising:
displaying a broadcast control component and a relative pose locking option in an extended reality space, wherein the broadcast control component comprises a video playing window and a playing control option, and the video playing window is configured to play a video; and
setting a relative pose of a user’s head and the broadcast control component to a locked state in response to a select operation on the relative pose locking option, wherein in a case where the relative pose of the user’s head and the broadcast control component is in the locked state, the broadcast control component moves with the user’s head, and the relative pose of the user’s head and the broadcast control component is always kept unchanged.

2. The method of claim 1, further comprising:
acquiring user head pose change information in a case where the relative pose of the user’s head and the broadcast control component is in the locked state;
determining first pose information of the broadcast control component based on the user head pose change information; and
setting pose information of the broadcast control component to the first pose information, such that the broadcast control component moves with the user’s head, and the relative pose of the user’s head and the broadcast control component is always kept unchanged.

3. The method of claim 2, wherein determining the first pose information of the broadcast control component based on the user head pose change information comprises:
determining initial pose information of the broadcast control component in the extended reality space and initial pose information of the user’s head in the extended reality space at an initial time, wherein the initial time is a time when the select operation on the relative pose locking option is detected;
determining a relative pose between the user’s head and the broadcast control component based on the initial pose information of the broadcast control component in the extended reality space and the initial pose information of the user’s head in the extended reality space at the initial time; and
determining the first pose information of the broadcast control component based on the user head pose change information and the relative pose between the user’s head and the broadcast control component.

4. The method of claim 2, wherein in response to the video played by the broadcast control component being a panoramic video, the panoramic video having a geometric model corresponding thereto, and a relative pose of the broadcast control component and the geometric model being fixed, the method further comprises:
determining the relative pose of the broadcast control component and the geometric model;
determining second pose information of the geometric model based on the first pose information of the broadcast control component and the relative pose of the broadcast control component and the geometric model; and
setting pose information of the geometric model to the second pose information.

5. The method of claim 2, further comprising:
determining a user head moving distance based on the user head pose change information in a case where an extended reality device is in a see-through mode; and
in response to the user head moving distance being greater than a set distance threshold, increasing transparency of the broadcast control component.

6. The method of claim 1, wherein displaying the relative pose locking option in the extended reality space comprises:
displaying the relative pose locking option in the extended reality space in a case where an extended reality device is in a first working mode, wherein the first working mode comprises an all-black mode or a see-through mode.

7. The method of claim 1, comprising:
setting a relative pose of a user’s head and the broadcast control component to an unlocked state in response to an instruction to switch a working mode of an extended reality device to a second working mode, wherein in a case where the relative pose of the user’s head and the broadcast control component is in the unlocked state, the broadcast control component does not move with the user’s head, the relative pose of the user’s head and the broadcast control component is variable, and the second working mode comprises a virtual viewing mode.

8. An electronic device, wherein the electronic device comprises:
one or more processors; and
a storage apparatus, configured to store one or more programs,
wherein the one or more programs, when executed by the one or more processors, cause the one or more processors to implement an interaction method comprising:
displaying a broadcast control component and a relative pose locking option in an extended reality space, wherein the broadcast control component comprises a video playing window and a playing control option, and the video playing window is configured to play a video; and
setting a relative pose of a user’s head and the broadcast control component to a locked state in response to a select operation on the relative pose locking option, wherein in a case where the relative pose of the user’s head and the broadcast control component is in the locked state, the broadcast control component moves with the user’s head, and the relative pose of the user’s head and the broadcast control component is always kept unchanged.

9. The electronic device of claim 8, wherein the method further comprises:
acquiring user head pose change information in a case where the relative pose of the user’s head and the broadcast control component is in the locked state;
determining first pose information of the broadcast control component based on the user head pose change information; and
setting pose information of the broadcast control component to the first pose information, such that the broadcast control component moves with the user’s head, and the relative pose of the user’s head and the broadcast control component is always kept unchanged.

10. The electronic device of claim 9, wherein determining the first pose information of the broadcast control component based on the user head pose change information comprises:
determining initial pose information of the broadcast control component in the extended reality space and initial pose information of the user’s head in the extended reality space at an initial time, wherein the initial time is a time when the select operation on the relative pose locking option is detected;
determining a relative pose between the user’s head and the broadcast control component based on the initial pose information of the broadcast control component in the extended reality space and the initial pose information of the user’s head in the extended reality space at the initial time; and
determining the first pose information of the broadcast control component based on the user head pose change information and the relative pose between the user’s head and the broadcast control component.

11. The electronic device of claim 9, wherein in response to the video played by the broadcast control component being a panoramic video, the panoramic video having a geometric model corresponding thereto, and a relative pose of the broadcast control component and the geometric model being fixed, the method further comprises:
determining the relative pose of the broadcast control component and the geometric model;
determining second pose information of the geometric model based on the first pose information of the broadcast control component and the relative pose of the broadcast control component and the geometric model; and
setting pose information of the geometric model to the second pose information.

12. The electronic device of claim 9, wherein the method further comprises:
determining a user head moving distance based on the user head pose change information in a case where an extended reality device is in a see-through mode; and
in response to the user head moving distance being greater than a set distance threshold, increasing transparency of the broadcast control component.

13. The electronic device of claim 8, wherein displaying the relative pose locking option in the extended reality space comprises:
displaying the relative pose locking option in the extended reality space in a case where an extended reality device is in a first working mode, wherein the first working mode comprises an all-black mode or a see-through mode.

14. The electronic device of claim 8, wherein the method comprises:
setting a relative pose of a user’s head and the broadcast control component to an unlocked state in response to an instruction to switch a working mode of an extended reality device to a second working mode, wherein in a case where the relative pose of the user’s head and the broadcast control component is in the unlocked state, the broadcast control component does not move with the user’s head, the relative pose of the user’s head and the broadcast control component is variable, and the second working mode comprises a virtual viewing mode.

15. A non-transitory computer-readable storage medium having a computer program stored thereon, wherein the computer program, when executed by a processor, implements an interaction method comprising:
displaying a broadcast control component and a relative pose locking option in an extended reality space, wherein the broadcast control component comprises a video playing window and a playing control option, and the video playing window is configured to play a video; and
setting a relative pose of a user’s head and the broadcast control component to a locked state in response to a select operation on the relative pose locking option, wherein in a case where the relative pose of the user’s head and the broadcast control component is in the locked state, the broadcast control component moves with the user’s head, and the relative pose of the user’s head and the broadcast control component is always kept unchanged.

16. The non-transitory computer-readable storage medium of claim 15, wherein the method further comprises:
acquiring user head pose change information in a case where the relative pose of the user’s head and the broadcast control component is in the locked state;
determining first pose information of the broadcast control component based on the user head pose change information; and
setting pose information of the broadcast control component to the first pose information, such that the broadcast control component moves with the user’s head, and the relative pose of the user’s head and the broadcast control component is always kept unchanged.

17. The non-transitory computer-readable storage medium of claim 16, wherein determining the first pose information of the broadcast control component based on the user head pose change information comprises:
determining initial pose information of the broadcast control component in the extended reality space and initial pose information of the user’s head in the extended reality space at an initial time, wherein the initial time is a time when the select operation on the relative pose locking option is detected;
determining a relative pose between the user’s head and the broadcast control component based on the initial pose information of the broadcast control component in the extended reality space and the initial pose information of the user’s head in the extended reality space at the initial time; and
determining the first pose information of the broadcast control component based on the user head pose change information and the relative pose between the user’s head and the broadcast control component.

18. The non-transitory computer-readable storage medium of claim 16, wherein in response to the video played by the broadcast control component being a panoramic video, the panoramic video having a geometric model corresponding thereto, and a relative pose of the broadcast control component and the geometric model being fixed, the method further comprises:
determining the relative pose of the broadcast control component and the geometric model;
determining second pose information of the geometric model based on the first pose information of the broadcast control component and the relative pose of the broadcast control component and the geometric model; and
setting pose information of the geometric model to the second pose information.

19. The non-transitory computer-readable storage medium of claim 16, wherein the method further comprises:
determining a user head moving distance based on the user head pose change information in a case where an extended reality device is in a see-through mode; and
in response to the user head moving distance being greater than a set distance threshold, increasing transparency of the broadcast control component.

20. The non-transitory computer-readable storage medium of claim 15, wherein displaying the relative pose locking option in the extended reality space comprises:
displaying the relative pose locking option in the extended reality space in a case where an extended reality device is in a first working mode, wherein the first working mode comprises an all-black mode or a see-through mode.
